(19) United States
(12) Patent Application Publication
(10) Pub. No.: US 2017/0129030 A1
(43) Pub. Date: May 11, 2017

(54) MODULAR ELECTROCHEMICAL MACHINING APPARATUS

(71) Applicant: WESTINGHOUSE ELECTRIC COMPANY LLC, Cranberry Township, PA (US)

(72) Inventor: LYMAN J. PETROSKY, LATROBE, PA (US)

(73) Assignee: WESTINGHOUSE ELECTRIC COMPANY LLC, Cranberry Township, PA (US)

(21) Appl. No.: 14/936,751

(22) Filed: Nov. 10, 2015

(51) Int. Cl. B23H 11/00; B23H 3/02; B23H 3/10

(52) U.S. Cl. CPC B23H 11/00; B23H 3/10; B23H 3/02

(57) ABSTRACT

An electrochemical machining apparatus is modular and includes a power module, an electrolyte processing module, an actuator module, and a control module that are connected with one another via a connection apparatus. The components are modular and are mounted on separate supports, many of which additionally include caster, and the connection apparatus is in the form of a removable umbilical. The modules can be individually moved to a location within a facility where a component is installed, and the modules can be interconnected to form the modular electrochemical machining apparatus at the location of the installed component. The apparatus can then perform an electrochemical machining operation in situ on the installed component.

### BACKGROUND

1. Field

The disclosed and claimed concept relates generally to equipment usable to perform machining operations and, more particularly, to a modular electrochemical machining apparatus.

2. Related Art

Numerous types of machining technologies are known in the relevant art. Some machining processes employ a cutting tool that is applied to a workpiece, with an amount of force being applied therebetween to remove some of the material of the workpiece. Such conventional processes employ machines such as saws, lathes, chisels, and the like. Other machining processes employ electricity to remove material rather than employing force, and such machining processes would include, for example, electrodischarge machining (EDM) processes and electrochemical machining (ECM) processes. While such machining methods have been generally effective for their intended purposes, they have not been without limitation.

As is generally known in the relevant art, EDM involves the application of electricity between an electrode and a metallic workpiece, and a spark jumps between the electrode and the workpiece to vaporize a particle of metal. EDM is thus relatively slow when compared with certain other processes because the spark at any given moment can only be in a single location and thus vaporizing an extremely small piece of material. EDM is also relatively costly because the electrode itself tends to become vaporized along with the workpiece.

ECM is relatively faster than EDM because it involves the application of a potential difference between a metallic workpiece and an electrode plus the application of an electrolyte between the workpiece and the electrode. The potential difference causes the material of the workpiece in proximity to the electrode to be placed into solution within the electrolyte. ECM can therefore be thirty or more times faster at removing material than EDM. However, ECM installations have had limited use in certain applications because of the large number of components that must cooperate with one another, the weight and size of such components, and the complexity of their interconnections. Improvements would thus be desirable.

### SUMMARY

An improved electrochemical machining apparatus is modular and includes a power module, an electrolyte processing module, an actuator module, and a control module that are connected with one another via a connection apparatus. The components are modular and are mounted on separate supports, many of which additionally include caster, and the connection apparatus is in the form of a removable umbilical. The modules can be individually moved to a location within a facility where a component is installed, and the modules can be interconnected to form the modular electrochemical machining apparatus at the location of the installed component. The apparatus can then perform an ECM operation in situ on the installed component.

Accordingly, an aspect of the disclosed and claimed concept is to provide an apparatus that is modular nature and that can perform an ECM operation in situ on an installed component.

Another aspect of the disclosed and claimed concept is to provide such an apparatus that is composed of separate modules that include components which are situated on separate supports and that are separately movable from one location to another to perform ECM operations at various locations in a facility.

Accordingly, an aspect of the disclosed and claimed concept is to provide an improved modular electrochemical machining apparatus that is structured to be moved to a location within a facility where a component is installed and to perform an electrochemical machining operation on the component. The modular electrochemical machining apparatus can be generally stated as including a power module that can be generally stated as including a power supply and a first support, the power supply being situated on the first support, an electrolyte apparatus that can be generally stated as including an electrolyte processing module, the electrolyte processing module can be generally stated as including a fluid circulation system structured to carry and circulate a quantity of electrolyte material and a second support, the fluid circulation system being situated on the second support, the second support being separate from the first support, a drive apparatus that can be generally stated as including an actuator module, the actuator module can be generally stated as including an actuator and a third support, the third support being separate from the first support and the second support and being structured to be affixed to at least one of the component and another structure of the facility that is situated in proximity to the component, the actuator can be generally stated as including a movable portion that is movable with respect to the third support between a first position with respect to the component and a second position with respect to the component as a part of the electrochemical machining operation, a control apparatus in operative communication with the actuator, and a connection apparatus structured to connect together the power module, the electrolyte apparatus, and the drive apparatus.

### BRIEF DESCRIPTION OF THE DRAWINGS

A further understanding of the disclosed and claimed concept can be gained from the following Description when read in conjunction with the accompanying drawings in which:

FIG. 1 is a diagrammatic view of an improved modular electrochemical machining apparatus in accordance with the disclosed and claimed concept;

FIG. 2 is a schematic depiction of a drive apparatus of the apparatus of FIG. 1;

FIG. 3 is a depiction of a plurality of electrodes usable by the apparatus of FIG. 1;

FIG. 4 is a schematic depiction of an electrolyte processing module of the apparatus of FIG. 1;

FIG. 5 is a schematic depiction of a control apparatus of the apparatus of FIG. 1; and

FIG. 6 is a connection diagram depicting the connections between the components of the apparatus of FIG. 1.

Similar numerals refer to similar parts throughout the specification.

### DESCRIPTION

An improved apparatus 4 in accordance with the disclosed and claimed concept is a modular electrochemical machining apparatus and is depicted as being situated inside a schematic facility 8 and disposed at a location 12 therein where a component 16 is installed within the facility 8. As will be set forth in greater detail below, the apparatus 4 is modular in nature and includes a plurality of components that are disconnectable from one another and are separately movable from one location to another within the facility 8 in order to perform ECM operations as needed in situ on installed components such as the component 16.

The apparatus 4 can be said to include a power module 20, an electrolyte apparatus 24, a drive apparatus 28, a control apparatus 32, and a connection apparatus 36. The connection apparatus 36 is in the form of an exemplary umbilical that connects the aforementioned components together and enables them to work together to be usable to perform ECM operations. The connection apparatus 36, in the depicted exemplary embodiment, is disconnectable from at least some of the aforementioned components to permit such components to be separately moved from one location to another.

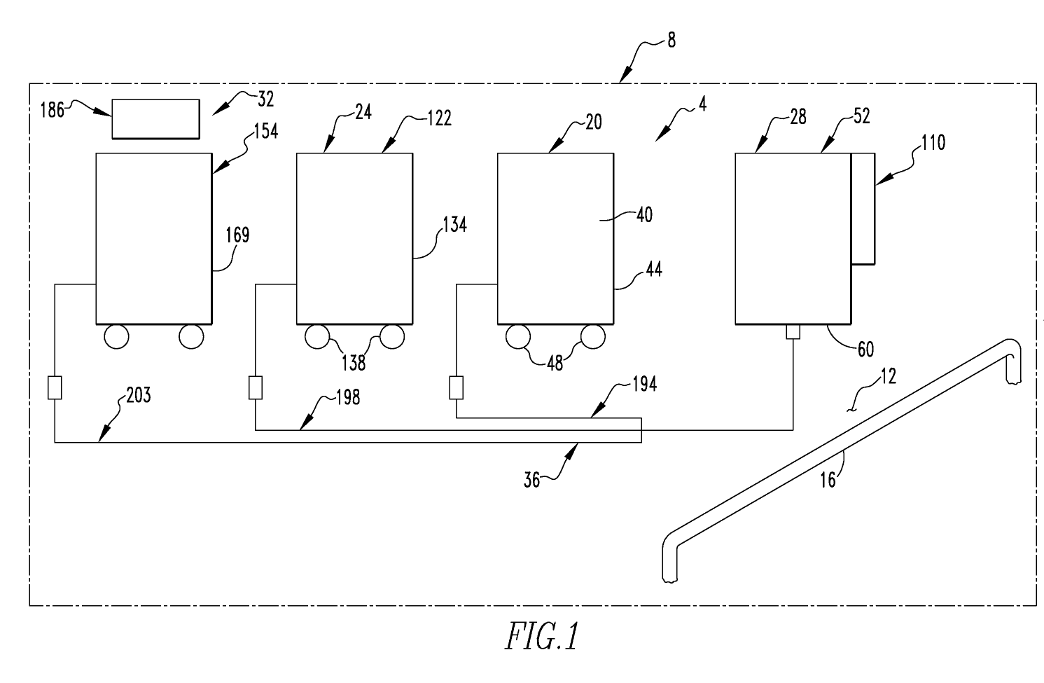

As can further be seen in FIG. 1, the power module 20 includes a power supply 40 that is situated on a support 44 that includes a set of casters 48. The power supply 40 is structured to be connected with an industrial power source such as single phase or three phase electrical power provided by a utility. The power supply 40 is configured to supply as many as several thousand Amperes of electrical power to the drive apparatus 28 as part of the ECM operation. The power supply 40 is also configured to supply operational electric power to at least some of the other components of the apparatus 4.

The drive apparatus 28 can be said to include an actuator module 52 that includes a robotic arm 56 or other type of actuator and a support 60. The support 60 is separate from the support 44, meaning that the two are movable independent of one another and are not affixed to one another.

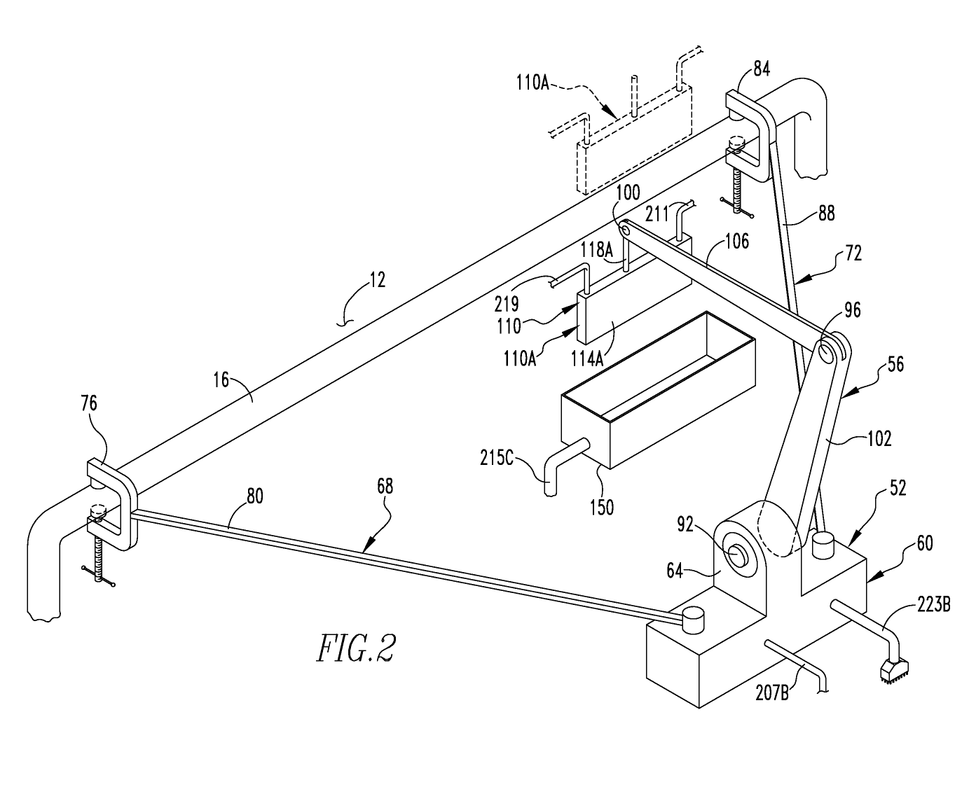

In the exemplary embodiment that is depicted generally in FIG. 2, the robotic arm 56 includes a base 64 that is situated on the support 60 and further includes a first attachment device 68 and a second attachment device 72 that are likewise situated on the support 60. The first and second attachment devices 68 and 72 are mountable to the component 16 in order to enable the support 60 to be affixed to the component 16. It is noted, however, that in other embodiments the support 60 may be configured to be situated on other structures or components of the facility 8 that are in proximity to the component 16 without departing from the present concept. The exemplary first attachment device 68 includes a first clamp 76 that is affixable to the component 16 and a first strut 80 that extends between the first clamp 76 and the support 60. The second attachment device 72 likewise includes a second clamp 84 that is affixable to the component 16 and a second strut 88 that extends between the second clamp 84 and the support 60. The first and second attachment devices 68 and 72 are affixable to the exemplary component 16 and retain the support 60 in a fixed position with respect to the component 16.

The robotic arm 56 can be said to itself be an actuator and is depicted in FIG. 2 as including a first actuator 92 and a second actuator 96. The robotic arm 56 further includes a quick disconnect socket 100 that is structured to quickly have connected therewith and disconnected therefrom a schematically depicted third actuator 118A that is a part of an electrochemical machining electrode 110A. The first, second, and third actuators 92, 96, and 118A are robotic actuators that are operable responsive to instructions from the control apparatus 32, as will be set forth in greater detail below. The robotic arm 56 further includes a first bar 102 that extends between the first and second actuators 92 and 96 and further includes a second bar 106 that extends between the second actuator 96 and the quick disconnect socket 100 that holds the third actuator 100. The first actuator 92 is affixed to the base. The first and second actuators 92 and 96 are independently operable to move the third actuator 118A among a plurality of positions with respect to the support 60.

The drive apparatus 28 can further be said to include the aforementioned electrode 110A, and the electrode 110A further includes an electrochemical machining electrode element 114A that is affixed to the third actuator 118A. The electrochemical machining electrode element 114A can also be referred to as an electrochemical machining die. The third actuator includes a stationary portion that is affixed to the quick disconnect socket 100 and a movable portion upon which the electrochemical machining electrode element 114A is situated. The entire electrode 110A can be said to constitute a movable portion that is movable with respect to each of the first and second actuators 92 and 96. While the electrode 110A with its integral third actuator 118A are depicted herein as being affixable via the quick disconnect socket 100 to the first and second actuators 92 and 96, it is noted that the electrode 110A could instead be mounted to a fixed support. In such a scenario, the third actuator 118A would move the electrode element 114A among a plurality of positions with respect to the component 16 in order to perform the electrochemical machining operation.

The drive apparatus 28 in the depicted exemplary embodiment can be said to include a plurality of electrodes that can be individually or collectively referred to herein with the numeral 110. That is, the electrodes 110 include the electrode 110A that is shown in FIGS. 2 and 3 and further include a pair of other electrodes 110B and 110C that are depicted in FIG. 3. The electrodes 110 are quickly and easily interchangeably affixable to and removable from the quick disconnect socket 100 and will be described in greater detail below.

Referring further to FIG. 2 and the electrode 110A, it is noted that the third actuator 118A is operable independently of the first and second actuators 92 and 96 to move the electrode element 114A that is affixed thereto among a plurality of positions with respect to the second bar 106 and the component 16 to perform an ECM operation. For instance, the electrode 110A is depicted in solid lines in FIG. 2 as being in a first position with respect to the component 16 and is additionally depicted in dashed lines in FIG. 2 as being in a second position with respect to the component 16. The exemplary first position is where the electrode may be situated at the start of an ECM operation before being moved by the robotic arm 56 into proximity with the component 16. The exemplary second position is the location in proximity with the component 16 where the electrode 110 may be positioned by the robotic arm 56 just prior to the time at which the electrode is energized by the power supply 40.

The electrode element 114A is the portion of the electrode 110A that actually performs the ECM operation on the component 16, and the actuator 118A is what moves the electrode element 114A among a plurality of positions with respect to the component 16. Likewise, the electrode 110B includes an electrode element 114B that is of an annular shape and is affixed to an integral third actuator 118B. Similarly, the electrode 110C includes an electrode element 114C and is affixed to an integral third actuator 118C. The third actuators 118A, 118B, and 118C may be individually or collectively referred to herein with the numeral 118. The electrode elements 114A, 114B, and 114C may be individually or collectively referred to herein with the numeral 114. The electrode elements 114 can each be said to be affixed to a corresponding integral third actuator 118, meaning that each electrode element 114 and its corresponding third actuator 118 that is affixed thereto together form an individual component that can be quickly connected with an released from the quick disconnect socket 100 to interchangeably connect any of the electrodes 110A, 110B, and 110C with the robotic arm 56. The electrodes 110A, 110B, and 110C are usable in various ECM applications to remove material from a workpiece such as the component 16 in a desired fashion through manipulation of the robotic arm 56 and/or the third actuator 118 and by performing other operations, such as will be set forth in greater detail below. It is understood that in other embodiments the electrode elements 114 can be configured without an integral third actuator 118 without departing from the present concept.

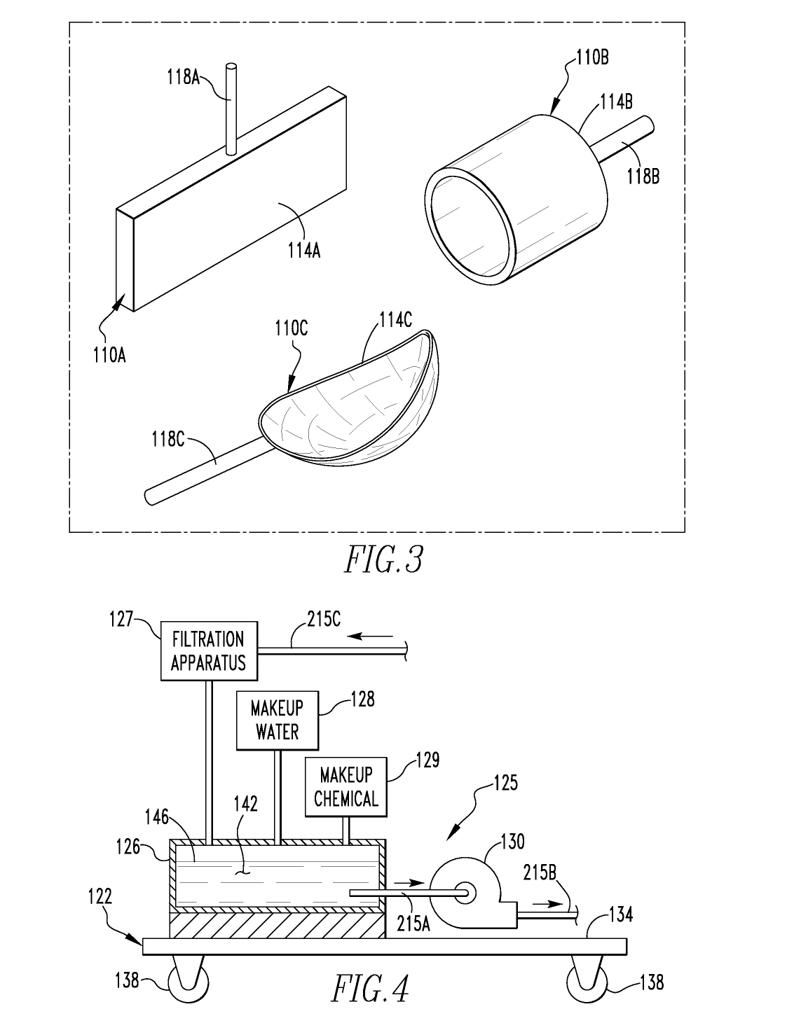

The electrolyte apparatus 24 can be said to include an electrolyte processing module 122 that is depicted in generally in FIG. 4. The electrolyte processing module 122 includes a fluid circulation system 125 that includes a tank 126 and a pump 130 that are in fluid communication with one another. The exemplary fluid circulation system 125 further includes a filtration apparatus 127, a makeup water reservoir 128, and a makeup chemical reservoir 129.

The electrolyte processing module 122 further includes a support 134 upon which the fluid circulation system 125 is situated. The support 134 includes a set of casters and is separate from the support 60 and from the support 44, meaning that the supports 44, 60, and 134 are not affixed to one another and are movable independently of one another. The tank 126 has an interior region 142 that is configured to carry therein an amount of electrolyte 146 which, in the depicted exemplary embodiment, is an aqueous solution of sodium nitrate. Other electrolytes can be employed without departing from the present concept. The pump 130 is operable to pump the electrolyte 146 to the electrode 110 for application to the component 16.

The exemplary tank 126 is a volumetric buffering tank, and it additionally is in fluid communication with the filtration apparatus 127, the makeup water reservoir 128, and the makeup chemical reservoir 129. The filtration apparatus 127 receives the electrolyte 146 return flow via at least the fluid channel 215C and removes precipitates from the recovered electrolyte 146 by typically first employing a centrifuge, then by subsequently employing a filter cartridge. The makeup chemical reservoir 129 stores therein a nominal amount of the chemical which, when placed in solution, forms the electrolyte 146 and which is provided to the tank 126 in order to make up any portions of the electrolyte chemical that may have been lost or may have been unrecoverable during the ECM operation. The makeup water reservoir 128 stores therein an amount of water that can be provided to the tank 126 to make up nominal amounts of water that may have been lost during the ECM operation and to adjust the concentration of the chemicals in the electrolyte solution.

The electrode 110 is therefore in fluid communication with the fluid circulation system 125 and, more specifically, with the pump 130. The electrolyte processing module 122 will typically additionally include electrolyte monitoring instrumentation, and may include other components as may be desirable.

The electrolyte apparatus 24 further includes an electrolyte collector 150 that is depicted in FIG. 2 as being in proximity to the component 16 and the electrode 110. The electrolyte collector 150 is configured to capture the electrolyte liquid after it has been in physical contact with the component 16 and is further configured to return the captured electrolyte 146 to the tank 126, such as through the fluid channel 215C. The electrolyte collector 150 is therefore in fluid communication with the tank 126.

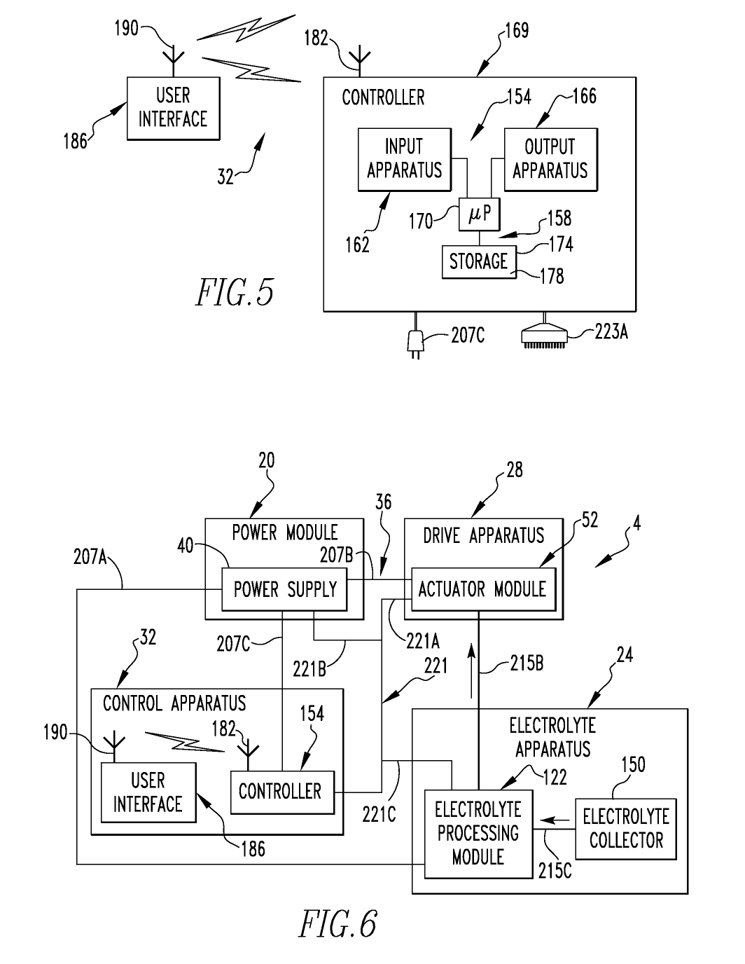

As can be seen in FIG. 5, the control apparatus 32 includes a controller 154 that can be said to include a processor apparatus 158, an input apparatus 162 that provides input signals to the processor apparatus 158, and an output apparatus 166 that receives output signals from the processor apparatus 158. The controller 154 further includes a support 169 upon which the processor apparatus 158, the input apparatus 162, and the output apparatus 166 are situated. The support 169 is separate from the supports 134, 60, and 44 and is movable independently of them.

The processor apparatus 158 can be said to include a processor 170 such as a microprocessor or other processor, and to further include a storage 174 that is connected with the processor 170. The storage 174 can be any of a wide variety of non-transitory storage media such as RAM, ROM, EPROM, FLASH, and the like without limitation and can operate in the fashion of a memory or a central storage or both of the processor apparatus 158. The processor apparatus 158 further includes a number of routines 178 that are in the form of instructions that are stored in the storage 174 and that executable on the processor 170 to cause the apparatus 4 to perform certain operations, including operations that are a part of an ECM operation. As employed herein, the expression “a number of” and variations thereof shall refer broadly to any non-zero quantity, including a quantity of one. The control apparatus 32 further include a first transceiver 182 that is electrically connected with the controller 154 and which, in the depicted exemplary embodiment, is a wireless transceiver. It is noted, however, that other types of transceivers, such as wired transceivers, can be employed without departing from the present concept.

The control apparatus 32 additionally includes a user interface 186 and a second transceiver 190 that are electrically connected with one another. The first transceiver 182 and the second transceiver 190 are in communication with one another. Such communication will likely be mostly or entirely via a digital network that can include the first and second transceivers 182 and 190 or can include other communication devices, it being noted that the specific types of communication devices are not necessarily critical, and rather they are more arbitrary. The user interface 186 can be said to include or to constitute a portion of the input apparatus 162 and a portion of the output apparatus 166, and it can be seen that the user interface 186 is physically separate from the controller 154 in the depicted exemplary embodiment. In other embodiments, the apparatus 162 and the controller 154 may be together situated on the same support.

The user interface 186 and the second transceiver 190 are typically going to be employed remotely from the controller 154, with the user interface 186 being usable by a technician or other individual to remotely operate the apparatus 4 via communication between the first and second transceivers 182 and 190. That is, the user interface 186 is usable to receive thereon commands and other inputs from a user and to communicate them to the controller 154 where they are input via the input apparatus 162 as input signals to the processor apparatus 158. Likewise, the user interface 186 is configured to provide visual outputs or audible outputs or both responsive to output signals being output from the processor apparatus 158 to the output apparatus 166 and being communicated to the user interface 186. The user interface 186 thus likely includes a loudspeaker, a visual display, and a keypad, with the visual display and the keypad potentially being integrated into a touchscreen, by way of example. The user interface 186 can be of any of a wide variety of configurations without departing from the present concept.

The connection apparatus 36 can be said to include an electrical connection 194, a fluid connection 198, and a control connection 203 that are, in the depicted exemplary embodiment, connected together as a single umbilical that enables a plurality of different types of communications from one location to another. The various types of communications are depicted in a schematic fashion in FIG. 6.

The electrical connection 194 can be said to include a plurality of electrical lines that can be individually or collectively referred to herein with the numeral 207 and that are also more specifically referred to herein with the numerals 207A, 207B, and 207C. The electrical line 207A extends between the power supply 40 and the electrolyte processing module 122 and provides electricity to power the pump 130. The electrical line 207B extends between the power supply 40 and the robotic arm 56 in order to provide electricity to power the robotic arm 56 as well as to provide electrical power to the electrode 110 to perform the ECM operation. The electrical line 207C extends between the power supply 40 and the controller 154 and provides electrical power to operate it.

As can be seen in FIG. 2, the electrical connection 194 further includes an electrical connector 211 which is depicted in FIG. 2 as being affixed to the electrode 110A to provide electrical power to the electrode 110A itself for the ECM operation. The electrical connector 211 is quickly and easily connectable with the electrode 110A in order to enable it to perform the ECM operation and is quickly and easily disconnectable from the electrode 110A to enable it to be interchanged with the electrodes 110B or 110C, by way of example.

The fluid connection 198 can be said to include a plurality of fluid channels that can be individually or collectively referred to herein with the numeral 215 and that more specifically include a plurality of fluid channels that are indicated at the numerals 215A, 215B, and 215C. The fluid channels 215 provide fluid communication between the various components of the electrolyte apparatus and the electrode 110.

The fluid channel 215A is depicted in FIG. 4 as extending between the tank 126 and the pump 130 and permits fluid flow toward the pump 130. The pump 130 draws the electrolyte 140 from the tank 126 and pumps it to the location on the drive apparatus 28 wherein the ECM operation is performed on the component 16.

That is, the fluid channel 215B extends between the pump 130 and the electrode 110 and provides pressurized fluid flow to the electrode 110. As is generally understood in the relevant art, the electrodes 110 will each include a plurality of very fine passages that extend within the electrode 110 between the fluid connector 219 and an opposite face of the electrode 110A that is situated adjacent the component 16 (such as when the electrode 110A is in the position depicted by dashed lines in FIG. 2). The electrode 110 can thus be said to be in fluid communication with the tank 126 to provide a flow of the electrolyte 146 to the component 16 at the position where the ECM operation occurs.

The fluid channel 215C extends between the electrolyte collector 150 and the tank 126 to return the electrolyte 146 to the tank 126 after the flow of electrolyte 146 has been in physical contact with the component 16. The electrolyte collector 150 can be of any of a variety of configurations as needed to collect the runoff of the flow of the electrolyte 146 and can likewise be positioned as needed to collect the runoff.

As is depicted in FIG. 2, the fluid connection 198 includes a fluid connector 219 that is connected with the electrode 110A and that provides electrolyte 146 at an elevated pressure from the pump 130 directly to the electrode 110A. The fluid connector 219 is quickly and easily connectable to the electrode 110A in order to provide the flow of the electrolyte 146 to the electrode 110 to perform the ECM operation, and the fluid connector 219 is quickly and easily disconnectable to the electrode 110A in order to permit it to be interchanged with the electrodes 110B and 110C, by way of example.

The control connection 203 can be said to include a data bus 221 that includes a control-side control connector 223A and an actuator-side control connector 223B that are connectable together. The data bus 221 enables the flow of data, as at 221A, in the form of data and commands and the like between the controller 154 and the robotic arm 56 in order to cause the robotic arm 56 to move the electrode 110A in such a fashion that the ECM operation is performed. For instance, the feed rate and direction of the electrode 110 can be provided from the controller 154 to the robotic arm 56, and the robotic arm can communicate to the controller 154 the current position of the electrode 110, by way of example. The data bus 221 further enables the flow of data and commands, as at 221B, between the controller 154 and the power supply 40 such as by providing voltage, current, short, and fault data from the power supply 40 to the controller 154, and by providing power on/off and commanded voltage from the controller 154 to the power supply 40. The data bus 221 further enables the flow of data and commands, as at 221C, between the controller 154 and the electrolyte processing module 122. For example, flow rate, temperature, electrolyte chemistry, reservoir tank level, feed chemical inventories, filter differential pressure, debris sludge level, and the like can be communicated from the electrolyte processing module 122 to the controller 154. Similarly, the controller 154 can provide to the electrolyte processing module 122 commands such as flow on/off, commanded electrolyte flow rate, commanded chemical feed parameters, and the like. Other types of data and command communication flow can be envisioned.

The control-side control connector 223A and the actuator-side control connector 223B are quickly and easily connectable together to enable such data communication during an ECM operation, and the control-side control connector 223A and the actuator-side control connector 223B are quickly and easily disconnectable from one another to permit the controller 154 and the actuator module 52 to be moved independently of one another from one location to another.

It is noted that the exemplary connectors 211, 219, 223A, and 223B, as well as other connectors, are depicted herein in an exemplary fashion that is intended to depict the fact that the power module 20, electrolyte processing module 122, actuator module 52, and controller 154 are disconnectable from one another and are separately movable from one location to another within the facility 8 as needed to perform ECM operations. As such, any of a wide variety of connection configurations can be provided with the connection apparatus 36 in order to enable it to permit rapid connection and disconnection between the various components.

It thus can be seen that the apparatus 4 includes a plurality of separate components that are movable separately from one another but that are connectable together to enable the components together to form the apparatus 4 and to thereby perform ECM operations. That is, the use of the connection apparatus 36 to connect together the various components in the fashion depicted in FIG. 6 places, for instance, the electrode 110A in fluid communication with the tank 126, and likewise places the electrolyte collector 150 in fluid communication with the tank 126. Likewise, the connection apparatus 36 places the controller 154 in control connection with the actuator module 52 and may additionally be connected with the electrolyte processing module 122 to provide control of the operation of the pump 130, by way of example. Furthermore, the connection apparatus 36 enables the power supply 40 to be electrically connected with and to provide power to the controller 154, the electrolyte processing module 122 (more particularly the pump 130), and the actuator module 52 (to electrically operate the robotic arm 56 and to power the electrode 110).

The connection apparatus 36 can be in any of a wide variety of configurations that enable it to be connectable with and to be disconnectable from the various components of the apparatus 4 in order to enable such components to be connected together at a location where an ECM operation is to occur and to be disconnected from one another when the various components are desired to be moved to another location to perform another ECM operation, at which other location the components can again be connected together with the use of the connection apparatus 36.

Advantageously, therefore, the apparatus 4 is modular in nature and includes a plurality of separate components that are movable separately from one location to another. The apparatus 4, being modular, thus enable ECM operations to be performed in situ on installed components such as the component 16 at any of a variety of locations about the facility 8. Other advantages will be apparent.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A modular electrochemical machining apparatus structured to be moved to a location within a facility where a component is installed and to perform an electrochemical machining operation on the component, the modular electrochemical machining apparatus comprising:
a power module comprising a power supply and a first support, the power supply being situated on the first support;
an electrolyte apparatus comprising an electrolyte processing module, the electrolyte processing module comprising a fluid circulation system structured to carry and circulate a quantity of electrolyte material and a second support, at least a portion of the fluid circulation system being situated on the second support, the second support being separate from the first support;
a drive apparatus comprising an actuator module, the actuator module comprising an actuator and a third support, the third support being separate from the first support and the second support and being structured to be affixed to at least one of the component and another structure of the facility that is situated in proximity to the component, the actuator comprising a movable portion that is movable with respect to the third support between a first position with respect to the component and a second position with respect to the component as a part of the electrochemical machining operation;
a control apparatus in operative communication with the actuator; and
a connection apparatus structured to connect together the power module, the electrolyte apparatus, and the drive apparatus.

2. The modular electrochemical machining apparatus of claim 1 wherein the drive apparatus further comprises an electrochemical machining electrode that is affixable to the movable portion and that is structured to moved thereby between the first and second positions, the electrochemical machining electrode being structured to be electrically connected with the power supply and being further structured to be in fluid communication with the electrolyte processing module.

3. The modular electrochemical machining apparatus of claim 2 wherein the drive apparatus further comprises a plurality of electrochemical machining electrodes that include the electrochemical machining electrode that each include an integral actuator and that are interchangeably affixable to the drive apparatus.

4. The modular electrochemical machining apparatus of claim 2 wherein the connection apparatus comprises an electrical connection that includes at least a first electrical connector, the at least first electrical connector being disconnectably connected with one of the drive apparatus and the power supply to electrically connect together the electrochemical machining electrode and the power supply.

5. The modular electrochemical machining apparatus of claim 4 wherein the connection apparatus further comprises a fluid connection that includes at least a first fluid connector, the at least first fluid connector being disconnectably connected with one of the electrolyte apparatus and the drive apparatus to connect together in fluid communication the fluid circulation system and the electrochemical machining electrode.

6. The modular electrochemical machining apparatus of claim 5 wherein the electrolyte apparatus further comprises an electrolyte collector that is structured to collect at least a portion of a flow of the electrolyte after is has been in physical contact with the component, the electrolyte collector being connectable in fluid communication with the fluid connection.

7. The modular electrochemical machining apparatus of claim 3 wherein the actuator is electrically connected with the electrical connection to disconnectably electrically connect together the actuator and the power supply

8. The modular electrochemical machining apparatus of claim 1 wherein the electrolyte apparatus further comprises an electrolyte collector that is structured to collect at least a portion of a flow of the electrolyte after it has been in physical contact with the component, electrolyte collector being connectable in fluid communication with the fluid circulation system.

9. The modular electrochemical machining apparatus of claim 1 wherein the control apparatus comprises:
a processor apparatus comprising a processor and a storage;
an input apparatus structured to provide input signals to the processor apparatus;
an output apparatus structured to receive output signals from the processor apparatus;
the storage having a number of routines stored therein, the routines being executable on the processor and being structured to cause the actuator to move the movable portions between the first and second positions;
a user interface comprising at least a portion of the input apparatus and at least a portion of the output apparatus, the least portion of the input apparatus being structured to provide a number of input signals to the processor apparatus responsive to a number of user inputs, the least portion of the output apparatus being structured to provide at least one of a number of visual outputs and a number of audible outputs responsive to receiving a number of output signals from the processor apparatus;
a first transceiver electrically connected with at least the drive apparatus;
a second transceiver electrically connected with the user interface; and
the first and second transceivers being structured to be in communication with one another.
